(19) United States
(12) Patent Application Publication
(10) Pub. No.: US 2012/0286480 A1
(43) Pub. Date: Nov. 15, 2012

(54) Negative creep corrugated gasket and methods of manufacturing same

(76) Inventor: Anatoly Ivanovich Efremov, Silver Spring, MD (US)

(21) Appl. No.: 13/506,589

(22) Filed: May 1, 2012

Related U.S. Application Data
(63) Continuation-in-part of application No. 11/405,722, filed on Apr. 18, 2006, now abandoned.

(51) Int. Cl. F16L 17/00; B21D 5/06; B21D 22/00; F16J 15/02; B23C 3/28

(52) U.S. Cl. 277/626; 409/131; 72/343; 72/127

(57) ABSTRACT

A “negative creep” corrugated gasket of Shape Memory Alloy (SMA) for Bolted Flanged Connections (BFCs) operates under temperatures that are within the temperature interval of reverse martensitic phase transformation from martensite to austenite of the SMA. Gasket corrugation is shape-memorized to operating “swelling” at temperature of direct martensitic phase transformation from austenite to martensite of the SMA being compressed to obtain some quantity of residual contraction corresponding to stress-induced martensite formation. A free “swelling” of deformed gasket corrugation at operating temperature defines the “negative creep” effect of the gasket, and it is blocked by rigid flanges with appearance of reactive shape-recovering stresses between the gasket corrugation and flange surfaces. The reactive shape-recovering stresses have direction inverse to the direction of operating creep of the gasket providing leak-tight, multiple, automatic and continuous seal between the flanges of the BFC. Methods of manufacturing of “negative creep” corrugated gasket are disclosed.

### CROSS REFERENCE TO RELATED APPLICATIONS

This Patent Application is a continuation-in-part of earlier patent application Ser. No. 11/405,722 filed on Apr. 18, 2006 and Ser. No. 12/319,206 filed on Feb. 2, 2009.

### FEDERALLY SPONSORED RESEARCH

Not Applicable

### SEQUENCE LISTING OR PROGRAM

Not Applicable

### BACKGROUND OF THE INVENTION

1. Field of the Invention

The present invention relates to Bolted Flanged Connection's (BFC's) novel type of gasket that is manufactured from Shape Memory Alloy (SMA) and displays a “negative creep” effect at operating temperature of the BFC resulting from gasket operating “swelling” under conditions of long action of a variety of operating temperatures extending to more than 1000° C.

2. Prior Art

Bolted Flanged Connections with gaskets as sealing elements used in plant/piping systems of petroleum refining, petrochemicals, fossil fuel and nuclear power generation, aerospace, automobile, submarine shipbuilding, and other industries experience operating leakages due to loss of leak tightness of gasketed joints. The operating leakage consequences are difficult to estimate, but the possible fires, explosions and environmental pollution are closest relatives of the leakage events which lead to enormous material and financial losses due to plant shutdowns, production penalties, maintenance rework activities, equipment replacement or repair, and so on.

One of the main reasons of operating leakages through gasketed joint is a thickness loss of the gasket and decrease of the stress between the gasket and flanges due to creep of the gasket that operate under critical conditions of long action of operating temperatures and variable pressure from adjacent rigid flanges of the BFC. Many patent documents concerning to development of gasket materials and gasket styles underline the importance of operating leakage problem, and simultaneously they testify that all previous approaches proposing regular “excellent” materials or sophisticated gasket styles cannot guarantee the safe and extended service life of critical engineering plant/piping structures containing the BFCs with gasketed joints.

One of the popular ways to limit plant/piping leakages consists in the use of special techniques to create a multiple seal between adjacent flanges and gasket of the BFC. Doty proposed a metallic gasket having corrugated shape capable to create a multiple contact between gasket corrugation and flange surfaces. He was the first to disclose the principal idea of this approach in the oldest U.S. Pat. No. 222,388. Two U.S. Pat. No. 854,135 by Whittemore and No. 922,130 by Goetze were a further development of this idea. First of them discloses a fabric gasket comprising two-layer metallic disc that is formed of annular concentric corrugations with asbestos corrugated packing between metallic layers of the disc. The second of them claims metallic corrugations that are intended to form solid supports for asbestos packing. It can provide a fluid-tight seal because the packing material is held firmly and effectively against the lateral movement upon the metallic retaining disc of the packing.

The U.S. Pat. No. 1,030,055 to Darlington, U.S. Pat. No. 2,006,381 to Bailey, U.S. Pat. No. 3,595,589 to Henderson, U.S. Pat. No. 4,234,638 to Yamazoe et al., U.S. Pat. No. 4,676,515 to Cobb, U.S. Pat. No. 4,705,278 to Locasius et al., U.S. Pat. No. 4,795,174 to Whitlow, U.S. Pat. No. 5,421,594 to Becerra, 5,556,113 to Amorese et al., U.S. Pat. No. 5,558,347 to Nicholson, U.S. Pat. No. 6,092,811 to Bojarczuk et al. describe the practical approaches to create gasket materials and gasket styles providing multiple seal by utilizing the gasket cores of functionally corrugated metals encapsulated by protective envelopes.

All these inventions disclose approaches to form corrugated gasket cores that are preferably constructed of similar metals such as aluminum, brass, copper or stainless steels, e. g. 304,309, 310,316, 321, 347,410, 430, 501. The further selection of metal depends upon metallurgy of the flanges to be sealed, and on the degree of chemical resistance desired from the metal gasket core. This range includes Alloy 20, Hasalloy B and C, Inconel 600, Incolloy 825, Monel, and others.

It is well known that all these metals used in corrugated core fabrication experience inevitable creep under conditions of a variety of operating temperatures and load-induced stresses, so that the spring feature and trapping action of corrugated compressed gasket will be inevitable decreased during long exposure to the load and thermal influences. The creep of gasket materials is common characteristics of all existing gasket styles that try to improve a leakage tightness of the gasketed joints. This gasket operating creep defines a “passive” behavior of gaskets under critical operating conditions that inevitable leads to routine operating leakages.

The next two patent documents relate to application of Shape Memory Alloys (SMAs) as sealed materials.

The U.S. Pat. No 3,971,566 to Levinsohn discloses a metallic V-ring sealing member that is a thin bent plate with single convex curvilinear V-surface oriented in the radial direction of a screwed tubular hydraulic system perpendicularly to the axis of this system. The plate is fabricated from metal capable of undergoing an austenitic to martensitic state change upon cooling below a transition temperature, said temperature being below about −60° C., and of undergoing a further transformation from martensitic to austenitic state upon warming from below said temperature to a temperature of less than operating temperature of the system that is within the range of from about −54° C. to about 232° C. These temperatures define the transition temperature range of metals from which sealing plate of the invention may be fabricated. The metal from which the V-ring sealing plate is manufactured relates to SMA, and, after lateral additional bending of the V-ring plate due to axial displacement of a screwed adaptor of the tubular system realized at temperature below the temperature of martensitic state of the SMA, the opposed two free ends of the V-ring plate will be almost bridged, and hydraulic system may be further sealed by warming the V-ring plate to temperature corresponding to austenitic state. The sealing effect is similar to an end thrust provided by two opposed free ends of the V-ring plate which try to recover their initial undeformed position at temperature of austenitic state of the SMA and exert axial forces against the tubular adjacent members of the system. Temperature of austenitic state of the SMA is lower than operating temperature of the tubular system, and V-ring plate of SMA will be subjected to ordinary operating creep when temperature of the assembly will reach its operating magnitude.

The US Patent Application No. 2002/0187020 to Julien discloses a lock washer for locking a threaded fastener from loosening under vibration. The look washer has a corrugated configuration with a central hole that receives a bolt shank. The lock washer is made of either one of two types of Nitinol: Superelastic Type 55 Nitinol SMA having transition temperature above about 100° C. or Ultraelastic Type 60 Nitinol SMA having transition temperature of about 30° C. . . . 85° C., so that they remain in martensitic state in all normal conditions of use. Type 60 Nitinol has not significant elastic properties at all. Washers made from Type 55 Nitinol provide large elastic properties while attenuating the input force. The martensitic Nitinol initially yields during torquing of the nut to allow the nut to indent itself slightly into the lock washer. The martensitic Nitinol causes a transformation into stress-induced martensite due to indentation of the nut. The stress-induced martensite is strong and elastic to resist further deformation, and also exerts a preload on the bolt shank. The nut, indented into the lock washer, strongly resists turning under vibration, which effect is further enhanced by the vibration absorbing characteristics of the Nitinol. However, the ability of lock washer to provide a seal between the nut and adjacent structural member described by author cannot be realized physically due to inevitable leakage through the central hole of the washer having a necessary gate to receive the bolt shank. Finally, the author did not include this unrealizable feature of the lock washer into the claims of the invention.

The present invention discloses a novel type of corrugated gasket based on unusual behavior of the gasket at operating temperature of the BFC and described as a “negative creep” effect (“swelling”) of the gasket providing an “active” resistance of the gasket to its operating creep. This approach uses the feature of shape recovery of deformed corrugated gasket of SMA having temperature interval of reverse martensitic phase transformation from martensite to austenite that includes operating temperature of the BFC. The SMAs from which invented gasket is manufactured may have a large range of temperature intervals of reverse martensitic phase transformation extending to more than 1000° C. and suitable for a variety of operating temperatures of different BFCs used in critical industries such as aerospace, fossil fuel and nuclear power generation, submarine shipbuilding, petroleum refining, petrochemicals, and others.

### Objects And Advantages

It is, therefore, a primary object of the present invention to provide a creep free gasket of BFC based on the use of “negative creep” effect (“swelling”) of corrugated gasket manufactured from SMA having temperature interval of reverse martensitic phase transformation from martensite to austenite that includes operating temperature of the BFC.

The next object of the invention is to manufacture the “negative creep” corrugated gasket of SMA that is shape-memorized in advance to operating “swelling”. A circular gasket corrugation is designed to form a plurality of concentric, circular, parallel rings of convex-concave configuration that can be manufactured from SMA with two different technological methods: (1) milling of a flat sheet of SMA at temperature below the temperature of direct martensitic phase transformation from austenite to martensite of the SMA to create a necessary corrugated profile of the gasket; (2) using a spinning roller system with male and female dies to deform the flat sheet of SMA or a die-stamp to press the flat sheet of SMA at temperature below the temperature of direct martensitic phase transformation from austenite to martensite of the SMA.

The corrugated gaskets manufactured with technological method (1) will be shape-memorized in advance to operating “swelling” being compressed in a flat press at initial temperature below the temperature of direct martensitic phase transformation from austenite to martensite of the SMA to obtain some quantity of residual contraction corresponding to stress-induced martensite formation. The corrugated gasket manufactured with technological method (2) will be shape-memorized in advance to operating “swelling” when obtained rolled or stamped corrugation is rigidly fixed at initial temperature below the temperature of direct martensitic phase transformation from austenite to martensite of the SMA, and then it is subjected to continuous aging at temperature higher than temperature of reverse martensitic phase transformation from martensite to austenite of the SMA. After this procedure gasket corrugation is released from fixation at initial temperature below the temperature of direct martensitic phase transformation from austenite to martensite of the SMA and compressed at the same temperature in flat press to obtain some quantity of residual contraction corresponding to stress-induced martensite formation.

Shape-memorized to operating “swelling” corrugated gaskets can be used in BFCs of plant/piping systems being tightly placed between the rigid flanges. Gasket corrugations deformed in advance will try to recover their initial undeformed shape, i.e. “to swell”, at operating temperature of the BFCs. This shape-recovery will be blocked by rigid flanges with appearance of reactive shape-recovering stresses between the gasket corrugations and flange surfaces. Reactive shape-recovering stresses will have direction inverse to the direction of operating creep of the gaskets that corresponds to “negative creep” effect providing tight contact between the gasket corrugations and flange surfaces of the BFCs.

It is another object of the invention to provide the “negative creep” corrugated gasket of SMA that may be shape-memorized to the same operating “swelling” during the BFC's assemblage procedure. In this case the gasket corrugation will be compressed by bolt preload force with stress-induced martensite formation at initial temperature lower than temperature of direct martensitic phase transformation from austenite to martensite of the SMA.

A most important advantage of the present invention is a novel type of corrugated gasket of SMA that is absolutely different from any conventional one displaying unusual unprecedented “active” resistance to operating creep due to its “negative creep” effect (“swelling”) at operating temperature of the BFC.

Another advantage of the present invention consists in the use of reactive shape-recovering stresses between the gasket corrugation and flange surfaces. These stresses are generated at operating temperature of the BFC by multiple gasket corrugation that is shape-memorized to operating “swelling” due to stress-induced martensite formation after residual contraction of the gasket corrugation at initial temperature below the temperature of direct martensitic phase transformation of the SMA. The reactive shape-recovering stresses will have direction inverse to the direction of operating creep of the gasket forming tight contact between the gasket corrugation and flange surfaces.

Next advantage of the present invention consists in the gasket shape-memorization to operating “swelling” during the assemblage procedure at temperature lower than temperature of direct martensitic phase transformation from austenite to martensite of the SMA when gasket corrugation is contracted by bolt preload force forming stress-induced martensite. Gasket corrugation of SMA in martensite state will be deformed by relatively low torque that significantly decreases the stress and strain on the bolts.

### SUMMARY OF THE INVENTION

In accordance with the present invention, the corrugated gasket of the BFC is manufactured from different SMAs having temperature intervals of reverse martensitic phase transformation from martensite to austenite that include the variety of operating temperatures of the BFCs exceeding 1000° C. The gasket corrugation may be made using different technological methods (1) or (2) described above. Obtained gasket corrugation is then shape-memorized in advance to operating “swelling” depending on technological methods above. Milled gasket corrugation will be shape-memorized to operating “swelling” being compressed in flat press at initial temperature below the temperature of direct martensitic phase transformation of the SMA to obtain some quantity of residual contraction corresponding to stress-induced martensite formation. Stamped or rolled gasket corrugation will be shape-memorized to operating “swelling” being previously rigidly fixed at initial temperature below the temperature of direct martensitic phase transformation from austenite to martensite of the SMA followed by continuous aging at temperature higher than temperature of reverse martensitic phase transformation from martensite to austenite of the SMA. After this procedure gasket corrugation is released from fixation at initial temperature below the temperature of direct martensitic phase transformation from austenite to martensite of the SMA, and then it will be compressed in flat press at same initial temperature to obtain some quantity of residual contraction corresponding to stress-induced martensite formation.

Fabricated corrugated gasket is then tightly placed between the flanges of the BFC, and further gasket “swelling” at operating temperature of the BFC will be blocked by rigid flanges resulting in appearance of reactive shape-recovering stresses between the deformed gasket corrugation and rigid flanges due to constrained recovery of initial undeformed shape of the gasket corrugation. The reactive shape-recovering stresses have direction inverse to the direction of operating creep of the gasket that defines the “negative creep” of the gasket providing multiple leak-tight, automatic, reliable and continuous seal between adjacent flanges. Additionally, released from rigid fixation at initial temperature corrugated gasket may be shape-memorized to operating “swelling” being contracted by bolt preload force during assemblage procedure at same initial temperature that corresponds to stress-induced martensite formation.

Further brief description of applied drawings followed by detailed description of the invention is intended to provide a basis for understanding the nature and character of the present invention, and to explain the main principles and operation of presented “negative creep” corrugated gasket.

### BRIEF DESCRIPTION OF THE DRAWINGS

FIG. 1 is a cross-sectional view of a part of a circular gasket corrugation obtained after milling of the flat sheet of SMA at initial temperature below the temperature of direct martensitic phase transformation from austenite to martensite of the SMA to form a circular concentric profile of the gasket corrugation.

FIG. 2 is a final cross-sectional view of the part of a circular gasket corrugation obtained after stamping or rolling of the flat sheet of SMA at initial temperature below the temperature of direct martensitic phase transformation from austenite to martensite of the SMA to form a circular concentric profile of the gasket corrugation followed by rigid fixation of the corrugation at same initial temperature with further continuous aging at temperature higher than temperature of reverse martensitic phase transformation from martensite to austenite of the SMA and following release from rigid fixation at initial temperature.

FIG. 3 is the cross-sectional view of the part of milled, rolled or stamped corrugated gasket shown in FIGS. 1 and 2 obtained after compression in flat press at initial temperature below the temperature of direct martensitic phase transformation from austenite to martensite of the SMA that forms a stress-induced martensite due to residual contraction of the gasket corrugation corresponding to “negative creep” gasket design.

FIG. 4 is the cross-sectional view of the part of BFC at operating temperature “T” with “negative creep’ gasket shown in FIG. 3 that is tightly placed between the rigid flanges of the BFC and additionally compressed by bolt preload force providing reactive shape-recovering stresses σₛᵣ due to constrained shape recovery of initial undeformed gasket corrugation.

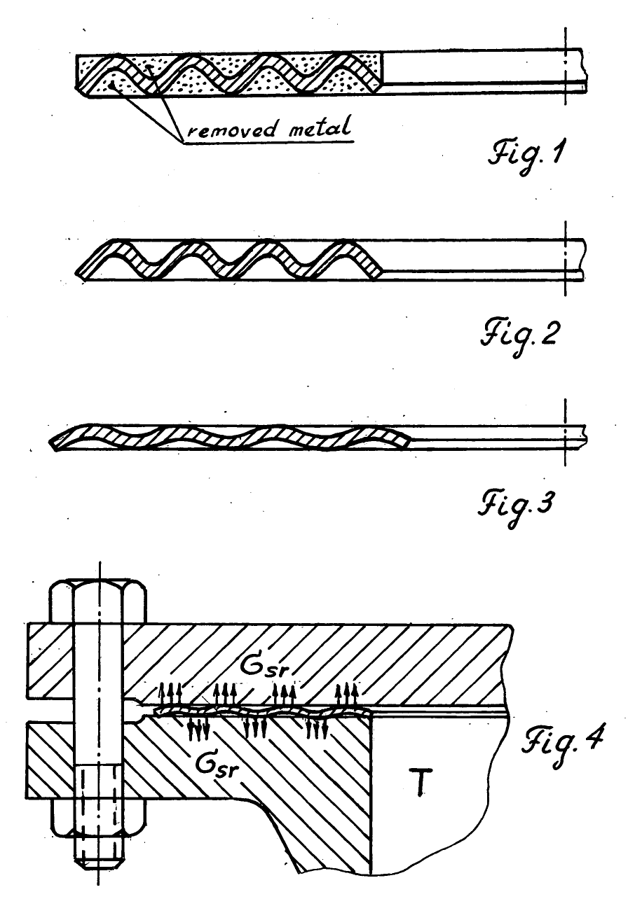

### DETAILED DESCRIPTION OF THE INVENTION

Operating creep of any conventionally used corrugated gaskets relates to their “passive’ behavior at operating temperature of the BFC that defines a gasket thickness decrease due to time-temperature aging effect of gasket metal compressed by bolt preload force. The gasket thickness decrease leads to unavoidable gape formation between gasket corrugation and flange surfaces accompanied by intensive leakages through a loose gasketed joint.

The present invention is based on “active” behavior of “negative creep” corrugated gasket of SMA resulting from operating gasket “swelling” at operating temperature of the BFC. In this case the gasket thickness will try to increase and recover its initial undeformed shape obtained at initial temperature below the temperature of direct martensitic phase transformation from austenite to martensite of the SMA after milling of the flat sheet of SMA. Initial undeformed gasket corrugation obtained from stamping or rolling of the flat sheet of SMA will be formed after its rigid fixation at initial temperature followed by continuous aging at temperature higher than temperature of reverse martensitic phase transformation from martensite to austenite of the SMA and next release from rigid fixation at initial temperature. The initially corrugated gasket will “remember” its initial undeformed corrugated shape. The initial undeformed shape of the gasket corrugation will be changed in advance during its compression in flat press at initial temperature. After this procedure the corrugated gasket will be shape-memorized to operating “swelling” obtaining some quantity of residual contraction corresponding to stress-induced martensite formation that defines future gasket “swelling” to restore initial undeformed shape at operating temperature of the BFC.

The circular corrugated gasket is manufactured from SMA having temperature interval of reverse martensitic phase transformation from martensite to austenite of the SMA that includes operating temperature of the BFC used in specific process temperature. The corrugation may have a plurality of concentric circular convex-concave rings such as sinusoidal, U-inverted U, trapezoidal, V-inverted V, or combination thereof.

The SMAs from which the corrugated gasket is manufactured may have the variety of temperature intervals of reverse martensitic phase transformation from martensite to austenite that include a large range from cryogenic temperatures to very high ones exceeding 1000° C. These SMAs are known today compositions of Ni—Ti—Fe, Ni—Ti—Cu, Ni—Ti—Nb, Ni—Ti, Cu—Al—Mn, Ni—Mn—Ga, Ni—Ti—Pd, Ti—Pd, Ni—Ti—Pt, Ti—Ni—Hf, Ti—Ni—Zr, Nb—Rb—Fe, Nb—Rb, Ta—Rb, and others. The SMA's selection will depend on operating temperature of the BFC with corrugated gasket as sealing element because operating temperature must be within the temperature interval of reverse martensitic phase transformation of the SMA.

Deformed in flat press “negative creep” corrugated gasket may be encapsulated by protective envelope manufactured from materials convenient for specific process conditions such as oxidation or chemical influences.

Ready to use “negative creep” corrugated gasket is then tightly placed between the rigid flanges of the BFC at temperature of assemblage procedure as shown in FIG. 4, and it can be additionally compressed by bolt preload force. This temperature of assemblage is below the temperature of direct martensitic phase transformation from austenite to martensite of the SMA. The “negative creep” corrugated gasket will try to recover its initial undeformed shape at operating temperature “T” of the BFC that is within temperature interval of reverse martensitic phase transformation from martensite to austenite of the SMA. This shape recovery (“swelling”) will be blocked by rigid flanges providing constrained shape recovery of the gasket corrugation accompanied by appearance of reactive shape-recovering stresses σₛᵣ between the gasket corrugation and flange surfaces as shown in FIG. 4. The reactive shape-recovering stresses have direction inverse to the direction of operating creep of the gasket that corresponds to “negative creep” effect. The reactive shape-recovering stresses create a multiple leak-tight seal between the gasket and flanges providing safe and extended service life of the BFC used in critical “time-temperature-internal pressure” operating conditions.

### Conclusion, Ramification and Scope

Presented “negative creep” corrugated gasket of SMA is shape-memorized in advance to operating “swelling” being contracted at temperature below the temperature of direct martensitic phase transformation from austenite to martensite of the SMA and obtaining some quantity of residual contraction of the gasket corrugation that corresponds to stress-induced martensite formation. The contracted gasket corrugation will try to recover its initial undeformed shape, i.e. “to swell”, at operating temperature of the BFC that is within the temperature range of reverse martensitic phase transformation from martensite to austenite of the SMA. This “swelling” defines the “negative creep” effect, but shape recovery of the gasket corrugation will be blocked by adjacent rigid flanges of the BFC leading to appearance of reactive shape-recovering stresses between deformed gasket corrugation and flange surfaces. The reactive shape-recovering stresses have direction inverse to the direction of operating creep of the gasket corresponding to “negative creep” effect.

The “negative creep” effect of the corrugated gasket is a basis to limit or completely exclude plant/piping operating leakages providing multiple leak-tight, automatic and continuous seal between adjacent flanges of the BFC used in engineering structures that operate under critical conditions including internal pressure and variety of operating temperatures extending to more than 1000° C.

The “negative creep” gaskets will find a large applicability in critical plant/piping systems used in aerospace, petroleum refining, petrochemicals, submarine shipbuilding, fossil fuel and nuclear power generation, and other industries. The scope of application of the “negative creep” gaskets is limited by some existing today types of the SMAs having relatively high cost or low plasticity, but inevitable progress in material science will provide all necessary SMAs to cover the needs of modem critical industries.

What is claimed is:

1. A “negative creep” gasket for leak-tight joint of Bolted Flanged Connection (BFC), the “negative creep” gasket with corrugated shape manufactured from Shape Memory Alloy (SMA) displaying a “negative creep” effect at operating temperature of said BFC resulting from gasket “swelling” with appearance of reactive shape-recovering stresses between rigid flanges and gasket corrugation constrained by said rigid flanges, said reactive shape-recovering stresses having direction inverse to the direction of conventional operating creep and providing multiple seal of said BFC.

2. The “negative creep” corrugated gasket according to claim 1 manufactured from said SMA having temperature interval of reverse martensitic phase transformation from martensite to austenite that includes operating temperature of said BFC with said “negative creep” corrugated gasket as sealing member.

3. Manufacturing of “negative creep” circular corrugated gasket consisting in following first method:
milling of a flat sheet of SMA at temperature below the temperature of direct martensitic phase transformation from austenite to martensite of the SMA to obtain a necessary concentric profile of the gasket corrugation followed by contraction of a milled gasket corrugation in flat press at temperature below the temperature of direct martensitic phase transformation from austenite to martensite of the SMA to obtain a residual contraction of the gasket corrugation corresponding to stress-induced martensite formation.

4. Manufacturing of “negative creep” circular corrugated gasket consisting in following second method:
stamping or rolling of the flat sheet of SMA at temperature below the temperature of direct martensitic phase transformation from austenite to martensite of the SMA to obtain a necessary concentric profile of the gasket corrugation;
rigid fixation of the gasket rolled or stamped corrugation at temperature below the temperature of direct martensitic phase transformation from austenite to martensite of the SMA followed by constrained continuous aging at temperature higher than temperature of reverse martensitic phase transformation from martensite to austenite of the SMA;
release from rigid fixation of said gasket rolled or stamped corrugation at temperature below the temperature of direct martensitic phase transformation from austenite to martensite of the SMA;
contraction of released from rigid fixation rolled or stamped gasket corrugation in flat press at temperature below the temperature of direct martensitic phase transformation from austenite to martensite of the SMA to obtain residual contraction of the gasket corrugation corresponding to stress-induced martensite formation.
